(19) United States
(12) Patent Application Publication
(10) Pub. No.: US 2026/0132587 A1
(43) Pub. Date: May 14, 2026

(54) SYSTEM AND METHOD OF USING A HELICAL PILE AS A FOUNDATION TO ATTACH TO A BATTERY ENERGY STORAGE SYSTEM

(71) Applicant: Fluence Energy, LLC, Arlington, VA (US)

(72) Inventors: Farnam Ghasemzadehsomarin, Los Angeles, CA (US); Kevin Daniel Lopez, Whittier, CA (US); Geoffrey Denzil Miller, Littleton, CO (US)

(73) Assignee: Fluence Energy, LLC, Arlington, VA (US)

(21) Appl. No.: 18/853,248

(22) PCT Filed: Sep. 20, 2024
(86) PCT No.: PCT/US2024/047705

§ 371 Date: Oct. 1, 2024

Related U.S. Application Data
(60) Provisional application No. 63/539,923, filed on Sep. 22, 2023.

(51) Int. Cl. E02D 27/16; E02D 5/22; E02D 5/56; H01M 50/204; H01M 50/244; H01M 50/251; H01M 50/264

(52) U.S. Cl. CPC E02D 27/16; E02D 5/223; E02D 5/56; H01M 50/204; H01M 50/244; H01M 50/251; H01M 50/264; H01M 2220/10

(57) ABSTRACT

An energy storage system includes a plurality of energy storage nodes, each of which includes a battery storage element, and a plurality of helical piles for coupling the plurality of energy storage nodes to a solid substratum. Two adjacent energy storage nodes share a single helical pile or a fixed number of the plurality of helical piles is determined by site soil and seismic conditions. A method for attaching an energy storage system to a solid substratum is also provided.

### CROSS-REFERENCE TO RELATED APPLICATIONS

This application claims priority under 35 U.S.C. § 120 to U.S. Patent Application No. 63/539,923 filed on Sep. 22, 2023, titled “System and Method of Using a Helical Pile as a Foundation to Attach to a Battery Energy Storage System,” the entire disclosure of which is incorporated by reference herein.

### TECHNICAL FIELD

The present subject matter relates to systems and methods for affixing an energy storage system to solid substratum using helical piles.

### BACKGROUND

Battery energy storage systems, compound energy storage systems, as well as some energy provisioning systems, are often large structures designed to resolve a sustained energy provisioning need. Consequently, such energy systems are often fixed in place at a site, in order to improve reliability, safety, and overall performance. Traditionally, these energy system sites are selected for a naturally relatively flat grade across the entire site, and after selection the site is mechanically graded. After the site is graded, cement is poured into a slab and then is allowed to cure into concrete. After grading but before the concrete cures, connectors such as conduit may be installed in the slab form, allowing for conduit runs to be embedded under or within the cured concrete.

Concrete mat slabs introduce a myriad of difficulties to installation of energy systems. Site selection requires generally flat areas, areas which allow for flat concrete slabs to be poured the size of the unitary energy system components. As many unitary energy system components are at least the size of a shipping container, at minimum almost 350 square feet of nearly-level ground are required per energy system component—and in some scenarios it may be more effective to pour a relatively large cement slab, which could be the size of a commercial parking lot.

Regardless of the size, the flat area often needs to be re-graded mechanically, in order to level out any minor discrepancies in height. Re-grading can be a time intensive task, and may need to consider specific requirements of particular energy storage system components to be installed. For example, conduit runs may need to be accommodated, either in the act of re-grading, or in preparation of cement forms.

Concrete slabs (following the “7 to 70 rule”) take between seven and ten days to sufficiently cure in order to reach the targeted compression strength for supporting the energy system components. However, energy storage systems, being both dense and fixed in weight, often prefer to wait 28 days and achieve concrete of 90% strength, rather than wait a week for concrete of 70% strength. From a practical perspective, installation of the energy storage system requires a minimum of a week, and realistically a month, delay from pouring cement to installing energy system components. Remote installation sites will then either need to house installation technicians for a week or month of mostly idle time, or logistical timetables will need to be tightly adhered to in order to avoid wasting technician time as well as idling energy system time.

Concrete slabs, along with other conventional foundations designs, are susceptible to frost heave, unsuitable for bad soils, have extensive curing time, require excavation, are unsuited to certain-sized energy storage systems, are unsuited to certain weather conditions, require extensive labor, can have short lifespans and be difficult to demolish, and require large number of construction crew and heavy equipment such as agitator trucks to travel to remote locations along underdeveloped roads and paths.

Hence, there is a need for systems and methods for improved energy system foundations.

### SUMMARY

In a first example, an energy storage system 101 includes a plurality of energy storage nodes 105A-N, each of which includes a battery storage element 106A-N, and a plurality of helical piles 402A-N for coupling the plurality of energy storage nodes 105A-N to a solid substratum 404. Two adjacent energy storage nodes 105A-N share a single helical pile 402A-N or a fixed number of the plurality of helical piles 402A-N is determined by site soil and seismic conditions.

In a second example, a method for attaching an energy storage system 101 to a solid substratum 404 includes providing a plurality of energy storage nodes 105A-N, each of which includes a battery storage element 106A-N, and coupling each of the plurality of helical piles 402A-N to a corresponding one of the energy storage nodes 105A-N. Two adjacent energy storage nodes 105A-N share a single helical pile 402A-N or a fixed number of the plurality of helical piles 402A-N is determined by site soil and seismic conditions.

In a third example, a system includes a plurality of helical piles 402A-N each configured to couple one or more of a plurality of energy storage nodes 105A-N to a solid substratum 404. Each of the plurality of energy storage nodes 105A-N includes a battery storage element 106A-N. A single helical pile 402A-N is configured to be shared by two adjacent energy storage nodes 105A-N or a fixed number of the plurality of helical piles 402A-N is determined by site soil and seismic conditions.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

The drawing figures depict one or more implementations in accordance with the present concepts, by way of example only, not by way of limitations. In the figures, like reference numerals refer to the same or similar elements.

FIG. 1 depicts a system that includes an energy storage system, an energy system, and an electrical application.

FIG. 2 illustrates a first energy storage node of a plurality of energy storage nodes of the energy storage system of FIG. 1 coupled to the electrical application.

FIG. 3 is a cutaway view of the first energy storage node of the plurality of energy storage nodes and shows details of a plurality of battery storage elements.

FIG. 4 is a diagram of utilizing piles, or grade beams, in support of energy storage system components, including strut and cabling positioning.

FIG. 5 shows design diagrams indicating where capped piles should be installed to support an energy storage system component, as well as design diagrams depicting the piles and caps.

FIG. 6 shows design diagrams of the grip installed within the energy storage system component, anchoring the energy storage system component to the pile cap.

FIG. 7 is a flowchart depicting a method for attaching an energy storage system to a solid substratum, according to an embodiment.

### PARTS LISTING

100 System
101 Energy Storage System
102 Energy System
103 Electrical Application
104 Power Conversion System
105A-N Energy Storage Nodes
106, 106A-N Battery Storage Elements
107 Power Conversion Subsystem
108 Transformer
109 Energy Source
110 Control Subsystem
111A-N Battery Data
112 Required Power Flow
112A-N Local Required Power Flows
113 Overall Operating Intent
115 Control System
116A-O Battery Conditions
117A-N Limits
118A-N Restrictions
119A-N Preferences
120 Physical Space
125 Power Bus
205 Power Inverter
210 Rectifier
215 DC-DC Converter
300 Enclosure
402A-N Helical Piles
404 Substratum
406A-N Cables
408A-N Struts
410A-N Grade Beams
412A-N Pile Foundation
502A-N Adjustable Pile Caps
504A-N Helical Pile Shafts
506A-N Pile Cap Holes
508A-N Through Bolts
602 Anchor Bolt
604A-B Anchor Nuts
606 Anchor Tab
700 Method

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, transfer functions, and/or circuitry have been described at a relatively high-level, without detail, in order to avoid unnecessarily obscuring aspects of the present teachings.

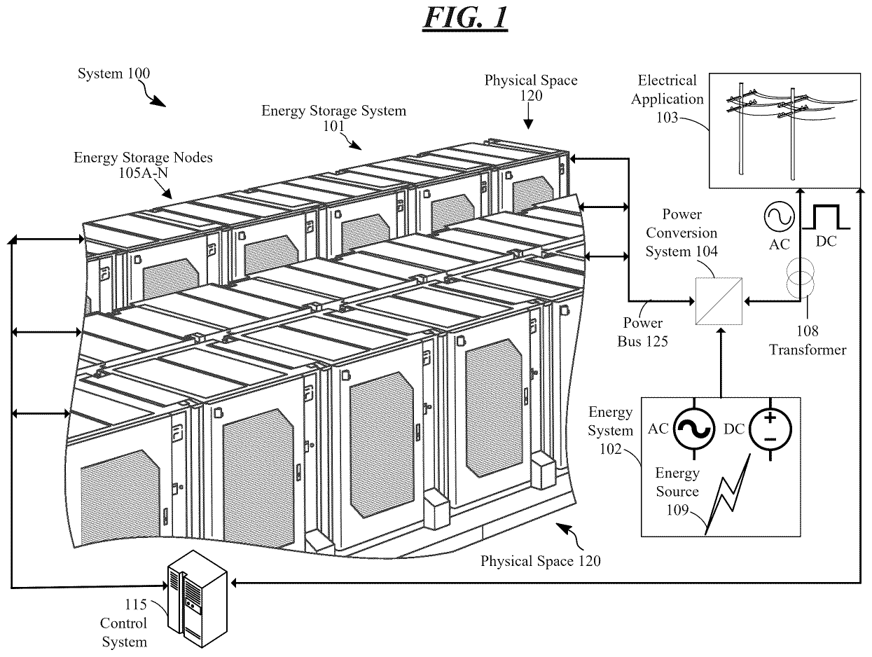

Unless otherwise indicated, any embodiment can be combined with any other embodiment. In particular, FIGS. 1-10 and the associated text are all combinable with each other.

The term “coupled” as used herein refers to any logical, physical, electrical, or optical connection, link or the like by which electricity, power, signals, or light produced or supplied by one system element are imparted to another coupled element. Unless described otherwise, coupled elements or devices are not necessarily directly connected to one another and may be separated by intermediate components, elements, or communication media that may modify, manipulate or carry the electricity, power, signals, or light.

The orientations of the system 100, energy storage system 101, energy storage nodes 105A-N, associated components, and/or any complete devices, incorporating battery storage elements 106A-N, such as batteries, such as shown in any of the drawings, are given by way of example only, for illustration and discussion purposes. In operation for a particular energy storage application, an energy storage node 105A-N may be oriented in any other direction suitable to the particular application of the energy storage system 101, for example upright, sideways, or any other orientation. Also, to the extent used herein, any directional term, such as left, right, front, rear, back, end, up, down, upper, lower, top, bottom, and side, are used by way of example only, and are not limiting as to direction or orientation of any energy storage system 101 or energy storage nodes 105A-N: or component of an energy storage system 101 or energy storage nodes 105A-N constructed as otherwise described herein.

Unless otherwise indicated, any coupled electrical components can be linked in series or in parallel. In the case of energy storage nodes 105A-N or battery storage elements 106A-N, the components may be linked in series, in parallel, or a combination thereof depending upon a state of a switch or a submodule.

The energy system foundation technologies disclosed herein identify and take advantage of pilings, including helical piles with and without adjustable pile caps, as well as other types of piles such as driven piles with adjustable pile caps. By obviating the need for concrete slab foundations for energy storage systems, energy systems can be installed quicker, cheaper, with less labor, and with less environmental and site impact.

Utilizing piles, in particular helical piles, as foundations for energy system components has several benefits. These technologies positively affect timelines for engineering and building an energy system project, thus massively reducing cost of preparing a site for energy systems, such as a battery energy storage system (BESS) installation. Helical piles are over twice as fast to install compared to the other available methods of foundation preparation such as concrete slabs, and that speed estimate is directed to installing the actual foundation components.

Piles require little to no site grading, potentially cutting out or heavily reducing the time taken to grade a site before the site is ready for foundation work to start. Piles also give the ability to land equipment immediately upon the pile-based foundation, whereas concrete-based foundations require curing. Concrete slabs also require teams of people (10-12) and testing for rebar, mix, and install, whereas pile, particularly helical pile, installation requires a team of 3 people. The helical pile installation team can be scales in groups of 3 for larger installations.

The piles, whether helical, driven, or otherwise, are connected to the energy storage system components via a pile cap affixed to the installed pile. The pile caps are adjustable in height. This adjustable-height pile cap, capping a pile as a foundation is beneficial over concrete slab foundations, as the pile-and-cap-based foundation would not require shimming as is needed for sites where the concrete poured does not come out level.

Further, attaching BESS equipment to the pile-capped piles simplifies installation. The piles and pile caps allow for some adjustability and variability in site levelness. Concrete slab installations utilize epoxy anchors to affix the BESS equipment to the foundation-epoxy anchors take more time to install and are not as adjustable as the pile caps.

Reference now is made in detail to the examples illustrated in the accompanying drawings and discussed below.

FIG. 1 depicts a system 100 that includes an energy storage system 101, energy system 102, and an electrical application 103. For example, the energy storage system 101 can be a battery energy storage system (BESS). The energy storage system 101 is coupled to the energy system 102 and the electrical application 103. Energy storage system 101 can include a power conversion system 104, a plurality of energy storage nodes 105A-N, an optional transformer 108, and a control system 115. Components of the energy storage system 101 can be located at a physical space 120 that is outdoors or indoors, for example, inside of a building, a container, or other structure.

As described further below, energy storage system 101 can be configured to determine limits 117A-N, restrictions 118A-N, or preferences 119A-N based on awareness of: (1) battery conditions 116A-O; and (2) a required power flow 112 or an overall operating intent 113 of the electrical application 103. The limits 117A-N, restrictions 118A-N, or preferences 119A-N are communicated to the control system 115. The control system 115 then determines how to divide dispatch of the required power flow 112 or the overall operating intent 113 across all of the energy storage nodes 105A-N based on the limits 117A-N, restrictions 118A-N, or preferences 119A-N.

Power conversion system 104 is coupled to the plurality of energy storage nodes 105A-N. The power conversion system 104 is coupled to the energy system 102 and the electrical application 103 to provide a required power flow 112 to the electrical application 103 by discharging the plurality of energy storage nodes 105A-N or the required power flow 112 from the energy system 102 for charging the plurality of energy storage nodes 105A-N. The power conversion system 104 can be coupled to an optional transformer 108. The optional transformer 108 can step up or step down the required power flow: 112 to and from the electrical application 103, such as an AC voltage.

Energy system 102 can include any suitable system for producing electrical energy from an energy source 109. Energy system 102 can be a renewable energy system in which the energy source 109 can be replenished. Such a renewable energy source 109 can include solar power, wind power, geothermal power, biomass, and hydroelectric power. For example, the renewable energy system 102 can be implemented as an array of photovoltaic modules. The photovoltaic (PV) modules can include crystalline silicon, amorphous silicon, copper indium gallium selenide (CIGS) thin film, cadmium telluride (CdTe) thin film, and concentrating photovoltaic which uses lenses and curved mirrors to focus sunlight onto small, but highly efficient, multi-junction solar cells. In another example, the energy system 102 can include wind turbines or gas turbines. In some examples, the energy system 102 can be a non-renewable energy system in which the energy source 109 includes a non-renewable energy source, such as a fossil fuel.

Electrical application 103 can include an electrical grid, such as a power grid, or a smaller local load, such as a backup power system, for a facility such as a hospital, manufacturing site, residential home, or other suitable facility. The electrical application 103 may deliver AC or DC power for on-grid or off-grid applications, including commercial, industrial, or residential applications. The electrical application 103 may deliver power to buildings, electric vehicle charging stations, etc., including a variety of electrical loads that consume AC or DC electric power. The electrical application 103 can be a front-of-the-meter system that is owned or operated by a utility company or a behind-the-meter system that directly supplies buildings and homes with electricity.

Energy source 109 can be a renewable energy source, such as solar power and wind power, which can be intermittent and less reliable compared to fossil fuels. To improve resiliency, energy storage system 101 can store energy from the energy system 102 when the production from the energy source 109 is high. Later on, the energy storage system 101 can dispatch the energy to the electrical application 103 when demand is high or production from the energy source 109 is not keeping up with demand. Moreover, events may occur when a connected load or an operating demand load of the electrical application 103 is excessive or there is electrical grid instability, such as during extreme weather. By storing energy from the energy source 109 and then dispatching the energy during such events, the energy storage system 101 can continue to dispatch a required power flow 112 of the electrical application 103.

Energy storage nodes 105A-N include battery storage elements 106A-N. The battery storage elements 106A-N can be: (1) a single battery cell: (2) a cell grouping, including several battery cells in parallel configuration: (3) a battery submodule or module, including several battery cells in parallel and serial configuration: (4) a battery string, including several battery modules in series: (5) a battery bank, including several battery strings in parallel: (6) other known energy storage elements; and/or (7) a combination thereof. For example, the battery storage elements 106A-N can include a plurality of batteries of any existing or future reusable battery technology, including lithium ion, flow batteries, or mechanical storage, such as flywheel energy storage, compressed air energy storage, pumped-storage hydroelectricity, gravitational potential energy, or a hydraulic accumulator.

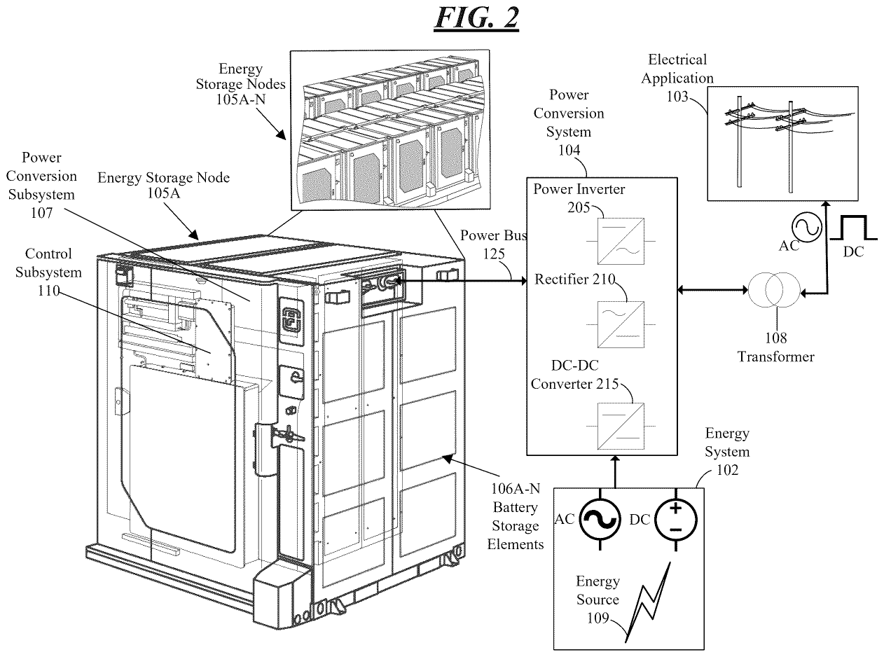

FIG. 2 illustrates a first energy storage node 105A of the plurality of energy storage nodes 105A-N of FIG. 1 coupled to the electrical application 103. Energy storage nodes 105A-N can include a battery storage element 106, a power conversion subsystem 107, and a control subsystem 110 to receive battery data 111A-N from the battery storage element 106, the power conversion subsystem 107, or a combination thereof. Energy storage system 101 can be controlled such that the electrical application 103 is fulfilled while distributing the dispatch of required power flow 112 across the plurality of battery storage elements 106A-N according to awareness of the control system 115 relating to certain battery conditions 116A-O, including a state of charge 116A, a temperature 116B, and other physical phenomena occurring within the battery storage elements 106A-N.

Power conversion system 104 can include a power inverter 205, a rectifier 210, a DC-DC converter 215, other power conversion elements, or a combination thereof. Power inverter 205 can be configured to convert a DC source, such as from the battery storage elements 106A-N, into an AC waveform. Rectifier 210 can be configured to convert an AC source, such as from the energy system 102 or electrical application 103, into DC for the battery storage elements 106A-N. DC-DC converter 215 can be configured to convert a DC source, such as from the battery storage elements 106A-N, into a different DC source characteristic.

If the energy source 109 is wind power, then the power conversion system 104 can convert the AC electricity produced into DC power for storage in the plurality of energy storage nodes 105A-N via the rectifier 210. If the energy source 109 is solar power, then the power conversion system 104 can convert the DC electricity into a different voltage level via the DC-DC converter 215. The power inverter 205 can convert the required power flow 112 from the energy storage system 101 from DC power into AC power during dispatch to the electrical application 103. For example, the power inverter 205 can be configured to convert power on a power bus 125 for use by the electrical application 103. For example, the power inverter 205 converts DC power stored in the energy storage nodes 105A-N into AC power for consumption by electrical loads of the electrical application 103.

Power conversion subsystem 107 includes similar hardware and software as the more centralized power conversion system 104. Power conversion subsystem 107 is distributed more locally to each of energy storage nodes 105A-N. The control subsystem 110 can be configured for local computation, processing, and control of the battery storage elements 106A-N and the power conversion subsystem 107. The control system 115 can be configured for more centralized computation, processing, and controls of the overall energy storage system 101, energy system 102, electrical application 103, and power conversion system 104. Both the control subsystem 110 and control system 115 can include a single board computer, an application-specific integrated circuit (ASIC), microcontroller, digital signal processor (DSP), field-programmable gate array (FPGA), or a combination thereof.

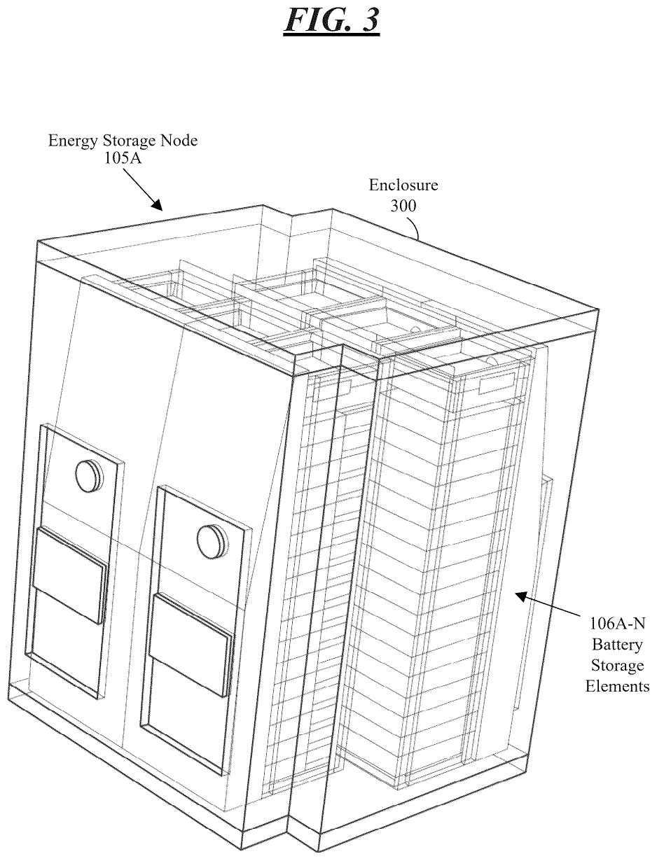

FIG. 3 is a cutaway view of the first energy storage node 105A of the plurality of energy storage nodes 105A-N and shows details of a plurality of battery storage elements 106A-N. As shown, the energy storage node 105A includes an enclosure 300, such as a physical housing to store a plurality of battery storage elements 106A-N. The battery storage elements 106A-N can be a collection of one or more batteries, such as a plurality of battery strings or battery banks, which are organized logically, physically, and electrically.

In the example of FIG. 3, the battery storage elements 106A-N can include battery racks (e.g., six are shown) that hold a respective stack of battery modules (e.g., seventeen are shown). The battery modules can include an array of prismatic, pouch, or cylindrical battery cells that are packaged together to increase voltage, amperage, or both. In some examples, battery modules may include an electric vehicle battery pack, e.g., a collection of lithium-ion battery cells that are packaged together.

The energy storage nodes 105A-N may resemble the features presented in the energy storage system described in International Application No. PCT/US2021/30551, filed on May 4, 2021, titled “Energy Storage System with Removable, Adjustable, and Lightweight Plenums,” the entirety of which is incorporated by reference herein.

An energy storage node 105A-N may constitute an energy storage system component, and may be affixed to one or more helical piles, via a pile cap, as described herein. Alternatively, multiple energy storage nodes 105A-N can be grouped into an energy storage system component, which can be affixed to one or more helical piles.

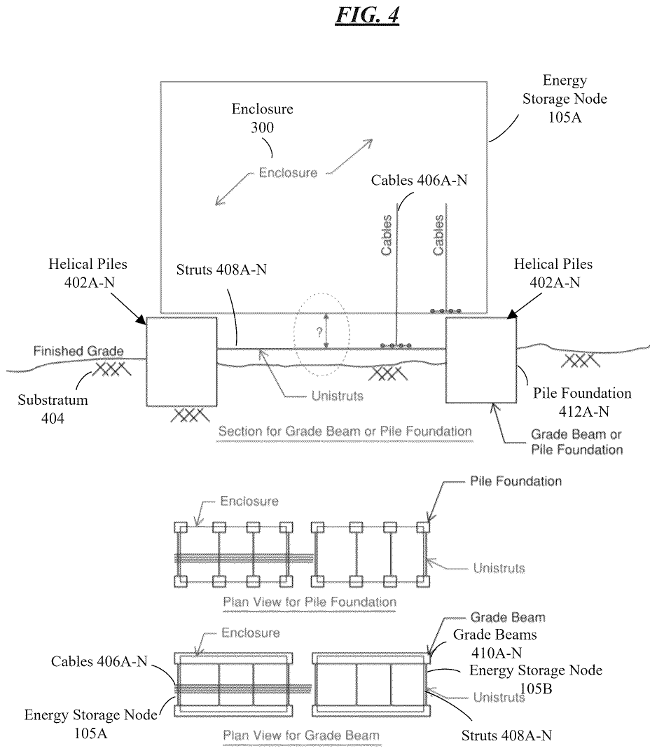

FIG. 4 is a diagram of utilizing helical piles 402A-N, or grade beams 410A-N, in support of energy storage system components, such as an energy storage node 105A housed in enclosure 300, for example, including strut and cabling positioning. In particular, FIG. 4 depicts struts 408A-N running between the helical piles 402A-N (or grade beams 410A-N, if used), upon which cables 406A-N or conduit may lay. Cables 406A-N and conduit may also lay inside of the energy storage system component (e.g., energy storage node 105A). By placing cables 406A-N on the struts 408A-N and the bottom of the energy storage system component (e.g., energy storage node 105A), the cables 406A-N can be protected from ground erosion, runoff, and small flora and fauna, while not requiring the cables 406A-N to be buried.

Helical piles 402A-N can be driven at the corners of each energy storage system component (e.g., energy storage nodes 105A-N). Energy storage system components 105A-N that are next to each other (e.g., adjacent energy nodes 105A-N) can share a single helical pile 402A-N.

Alternatively, a fixed number of helical piles 402A-N, the number of which can be determined by site soil and seismic conditions, may be used to support the energy storage system components (e.g., energy storage nodes 105A-N).

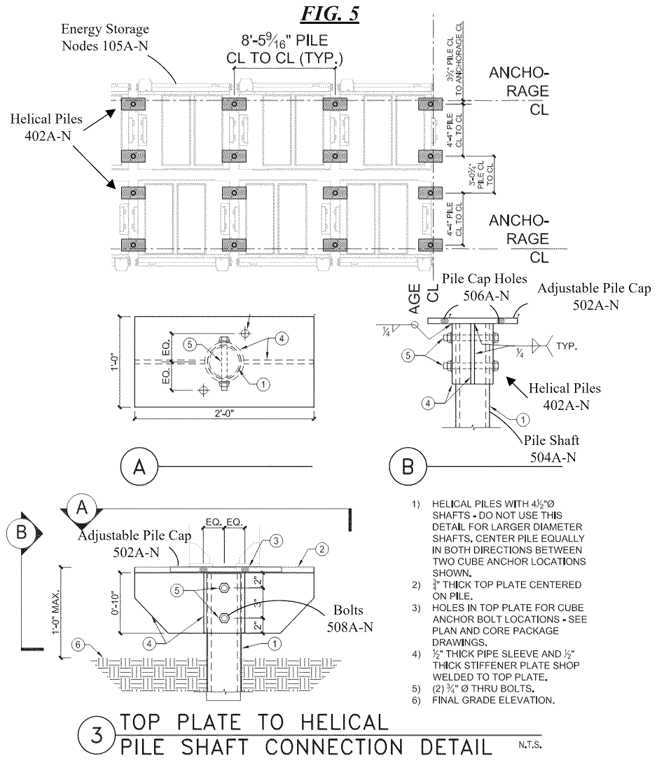

Turning now to FIG. 5, each of the helical piles 402A-N includes an adjustable pile cap 502A-N and a helical pile shaft 504A-N. The adjustable pile cap 502A-N is substantially centered on the helical pile shaft 504A-N.

Each of the adjustable pile caps 502A-N includes a plurality of holes 506A-N configured to connect the energy storage nodes 105A-N to a helical pile foundation 412A-N (FIG. 4).

Each of the helical piles 402A-N is substantially centered equally in both directions between two of the energy storage nodes 105A-N, as shown in FIG. 5, for example.

FIG. 5 further illustrates design diagrams indicating where capped piles 402A-N should be installed to support an energy storage system component (e.g., adjacent energy nodes 105A-N). In particular, FIG. 5 shows two energy storage system components (e.g., adjacent energy nodes 105A-N), each with an array of two-by-four helical piles 402A-N anchoring the energy storage system components (e.g., adjacent energy nodes 105A-N) to the ground.

Additionally, FIG. 5 illustrates detail of the connection between the top plate or adjustable pile cap 502A-N and the helical pile shaft 504A-N, depicting how the adjustable pile cap 502A-N connects to the pile 402A-N and can be adjusted to finely level the energy storage system component (e.g., adjacent energy nodes 105A-N).

As illustrated in FIG. 4, the helical piles 402A-N protrude from the surface of the soil. The helical piles 402A-N are drilled to approximately the same depth, but some variability can be tolerated in order to allow for the helical piles 402A-N to protrude to approximately the same altitude out of the soil. All helical piles 402A-N for the energy storage system 100 may reach the same altitude, resulting in all of the helical pile caps 402A-N being approximately level with one another.

Alternatively, only the helical pile caps 502A-N supporting a particular energy storage system component (e.g., adjacent energy nodes 105A-N) can deliberately protrude to the same altitude, resulting in the particular energy storage system component (e.g., adjacent energy nodes 105A-N) being level with itself, while not being level with other energy storage system components (e.g., adjacent energy nodes 105A-N) in the energy storage system 100.

Turning back to FIG. 5, each of the helical piles 402A-N includes at least two through bolts or screws 508A-N configured to be attached to the helical pile shaft 504A-N.

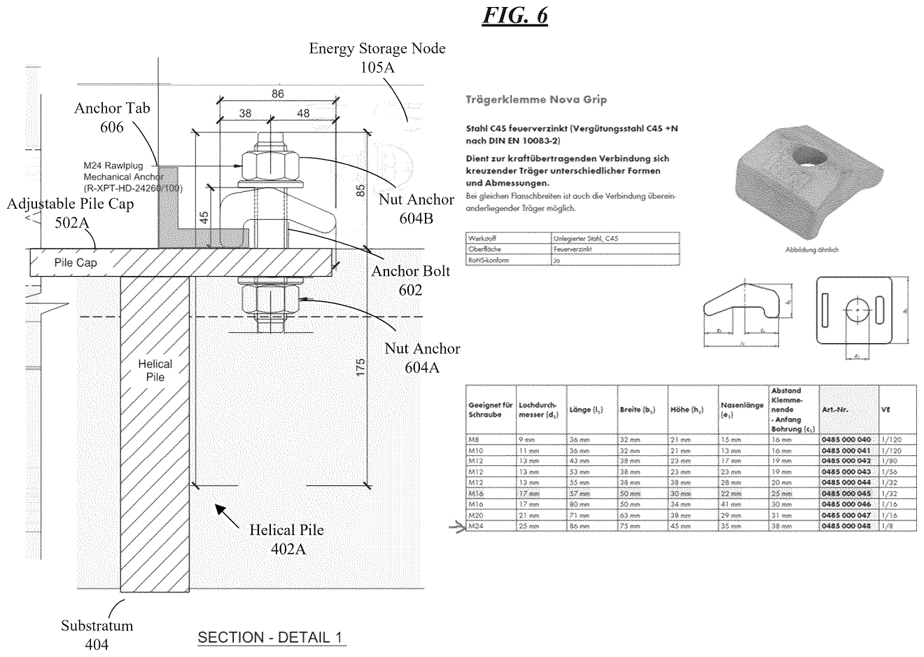

Each of the adjustable pile cap 502A-N is configured to attach to a corresponding one of the helical piles 402A-N and can be adjusted (in height) as necessary to level each of the energy storage nodes 105A-N with respect to the solid substratum 404. After the pile caps 502A-N are set, the pile caps 502A-N are drilled for an anchor clamp attachment that is through-bolted to the pile cap 402A-N (see FIG. 6). After equipment (e.g., energy storage system components 105A-N) is positioned on the helical piles 402A-N, the bolts 508A-N are tightened.

FIG. 6 illustrates design diagrams of the grip installed within the energy storage system component (e.g., energy node 105A), anchoring the energy storage system component to the pile cap 502A. In particular, FIG. 6 depicts an anchor bolt 602 with two nut mechanical anchors 604A and 604B, pressing a grip into an anchor tab 606 of the energy storage system component (e.g., energy node 105A) and the pile cap 502A, thereby affixing the energy storage system component 105A to the pile cap 502A, and therefore to the helical pile 402A, and therefore to the site or substratum 404.

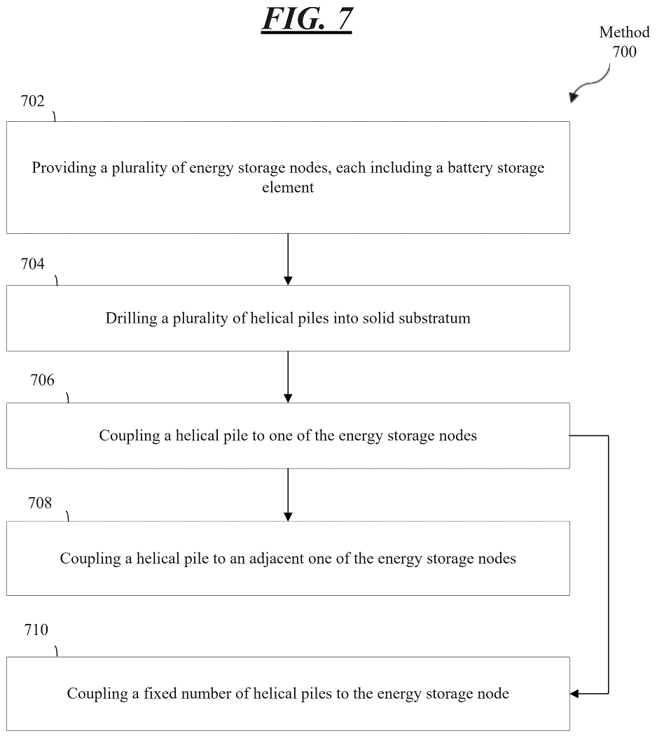

FIG. 7 is a flowchart of a method 700 for attaching an energy storage system 101 to a solid substratum 404. In the example of FIG. 7, the method 700 utilizes helical piles 402A-N to support energy storage system components, such as the energy storage node 105A housed in enclosure 300 of FIG. 4, for example.

Beginning in step 702, the method 700 includes providing a plurality of energy storage nodes 105A-N, each of which includes a battery storage element 106A-N (FIG. 2). The energy storage nodes 105A-N can include a battery storage element 106, a power conversion subsystem 107, and a control subsystem 110 to receive the battery data 111A-N from the battery storage element 106, the power conversion subsystem 107, or a combination thereof.

Continuing to step 704, the method 700 further includes drilling a plurality of helical piles 402A-N into the solid substratum 404.

Continuing to step 706, the method 700 further includes coupling a helical pile 402A-N to one of the energy storage nodes 105A-N. In certain embodiments, the helical piles 402A-N can be coupled to a corner of one of the energy storage nodes 105A-N.

Although not shown in FIG. 7, before step 706, the method 700 can further include a step of attaching an adjustable pile cap 502A-N to each of the plurality of helical piles 402A-N.

Although not shown in FIG. 7, before step 706, the method 700 can further include a step of centering an adjustable pile cap 502A-N on a helical pile shaft 504A-N of each of the plurality of helical piles 402A-N.

Although not shown in FIG. 7, before step 706, the method 700 can further include a step of drilling a plurality of pile cap holes 506A-N into the adjustable pile cap 502A-N of each of the plurality of helical piles 402A-N for an anchor clamp attachment.

The method 700 can further include a step of through-bolting the anchor clamp attachment to the adjustable pile cap 502A-N through the pile cap holes 506A-N drilled into the adjustable pile cap 502A-N.

The anchor clamp attachment can include an anchor bolt 602 with two nut mechanical anchors 604A and 604B configured to press a grip into an anchor tab 606 of the energy storage nodes 105A-N and the adjustable pile cap 502A-N.

Finishing now; in step 708, the method 700 further includes coupling a helical pile 402A-N to an adjacent one of the energy storage nodes 105A-N. In certain embodiments, the helical piles 402A-N can be coupled to a corner of an adjacent one of the energy storage nodes 105A-N.

Although not shown in FIG. 7, after step 708, the method 700 can further include a step of adjusting the height of the adjustable pile cap 502A-N to level each of the plurality of energy storage nodes 105A-N.

Although not shown in FIG. 7, after step 708, the method 700 can further include a step of installing each of the plurality of energy storage nodes 105A-N to one of the plurality of helical piles 402A-N and tightening the anchor bolts 602.

Alternatively, instead of step 708, in step 710, the method 700 can further include coupling a fixed number of the helical piles 402A-N to each of the energy storage nodes 105A-N. The fixed number of the helical piles 402A-N coupled to each of the energy storage nodes 105A-N can be determined based on the site soil and seismic conditions.

Mat slabs, or concrete slabs, which are the current standard for foundation construction supporting energy storage systems, cost almost 50% more than helical piles. Helical piles cost approximately the same as grade beams, which are concrete beams placed on the site and across which energy storage system components are laid and then affixed. Driven piles are again half the price of either helical piles or grade beams, but driven piles are only suited to soil environments that will accommodate the driven piles: if the soil is rocky, driven piles may hit large rock masses and be stopped from being driven in to a safe depth. Helical piles, which are screwed into the soil, can bypass rocky ground better than driven piles: further, if the helical pile shaft is pre-drilled, helical piles can be installed into soil of virtually any soil consistency.

Helical piles are also the quickest foundation to be installed, utilizing the smallest worker teams: three workers can install helical piles for an energy storage system of a certain size in two and a half days, while driven piles will take an extra half day, and grade beams and concrete slabs will take a full week. Therefore, helical piles outperform concrete slabs, and do so while avoiding the clear drawbacks of cheaper driven piles, which require acceptable soil.

Helical piles are cost-effective, and are simple in design and construction. Installation requires a smaller crew than other methods, who utilize less equipment. Piles also require substantially less grading, as the piles can be affixed at various depths, resulting in uniform heights. Additionally, pile caps allow for minute levelling adjustments, where concrete slabs once poured cannot be readjusted, only demolished, poured on top of, or shimmed.

Piles, particularly helical piles, allow for versatility: the piles can only be affixed where load weight requires support in the electrical storage system. Generally, this would be at corners and along load-bearing edges of the energy storage system components, but specific site architecture may allow or require piles in different locations. Piles, as they can elevate the energy storage system components off the ground, allow for versatility in cabling and conduit placement-cabling can simply be run in the crawlspace underneath and between energy storage system components, massively simplifying installation, maintenance, and upgrades.

Piles, particularly helical piles, can be removed and repositioned: therefore, if a site needs to be physically reconfigured, perhaps to accommodate wider or longer upgraded energy storage components, or to create wider thoroughfares and walkways between energy storage components, the energy storage components can be detached, the helical piles can be unscrewed, new holes can be drilled where needed, the helical piles can be re-affixed into the new holes, and the existing or new energy storage component can be affixed in the new position. Further, if the cabling or conduit was not buried but rather lain underneath the energy storage system components, those cables can be relatively easily adjusted to connect to the energy storage component in the new location.

Piles, particularly helical piles, also reduce environmental impact over concrete slabs. Concrete releases a large amount of CO₂ into the atmosphere while curing, while piles release minimal if any CO₂ during installation. Therefore, helical piles positively reduce environmental impact by reducing the emissions in the carbon footprint of the project by not using concrete or cement during construction. Cement production is energy-intensive and involves the release of carbon dioxide during the chemical process of producing cement, which is a substantial portion of global CO₂ emissions.

In terms of rainwater management, piles again are superior: concrete slabs are water impermeable, meaning that if an area has 10,000 square feet of concrete, allowances in water management, such as gullies and retention ponds. However, an extremely small amount of an energy storage system on a helical pile foundation is water impermeable: the area would be the cross-sectional area of the helical pile itself. If twenty-five shipping container-sized energy storage system components are affixed to 10,000 square feet of concrete, then there are 10,000 square feet of water impermeable surface. However, if those twenty-five components are each resting on four helical piles, and the helical pile has a 4.5 inch diameter shaft, then only approximately four square feet are water impermeable, according to the expression ((((4.5/2)\hat{ }2)*4*25))/ [symbol] 12 [symbol] \hat{ }2. This incredibly low water impermeability ratio means that, in the vast majority of implementations, surface area impermeability is a non-issue.

Finally, helical piles are both installed efficiently and consistently. Helical piles require small teams moving quickly to install piles, and once installed the piles are usable: it is possible that a second team could follow directly behind, affixing energy storage system components. Contrasted with concrete slabs, which require at least a week of curing after pouring cement, and the entire project timeline is both longer and substantially more complicated.

Helical piles then overall reduce environmental disturbance, which leads to the project being a sustainable land use, minimizing habitat fragmentation, utilizing low-impact construction, being resource efficient, conserving biodiversity, utilizing eco-friendly transportation, significantly lower carbon footprint compared to concrete slabs, easily recycled materials, and resulting in waste reduction over a traditional concrete slab project.

As previously discussed, helical piles require far less workers. Helical piles require 3 workers, materials including the helical piles, a skid steer with a torque head for drilling in the helical piles, and a truck and trailer for transporting everything. As helical piles do not use concrete, helical piles require zero hours of concrete cure time. Conversely, concrete pouring requires concrete formworks, a rebar truck, ten workers, a drill truck, concrete truck, a concrete pump, and 672 hours in this example for the concrete to cure.

It should be reiterated that, in some examples, the helical pile team may benefit from a drill truck, in order to pre-drill holes for the helical piles. It is contemplated that the skid steer itself may have a drill attachment and be capable of pre-drilling holes for the helical piles itself.

It will be understood that the terms and expressions used herein have the ordinary meaning as is accorded to such terms and expressions with respect to their corresponding respective areas of inquiry and study except where specific meanings have otherwise been set forth herein. Relational terms such as first and second, or evident and alternative, and the like may be used solely to distinguish one entity or action from another without necessarily requiring or implying any actual such relationship or order between such entities or actions. The terms “comprises.” “comprising.” “includes,” “including.” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as +5% or as much as +10% from the stated amount. The terms “approximately” and “substantially” mean that the parameter value or the like varies up to +10% from the stated amount or position.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

What is claimed is:

1. An energy storage system, comprising:
a plurality of energy storage nodes, wherein each of the plurality of energy storage nodes includes a battery storage element; and
a plurality of helical piles for coupling the plurality of energy storage nodes to a solid substratum,
wherein two adjacent energy storage nodes share a single helical pile or a fixed number of the plurality of helical piles is determined by site soil and seismic conditions.

2. The energy storage system of claim 1, wherein each of the plurality of helical piles is configured to be coupled to a corner of a corresponding one of the energy storage nodes.

3. The energy storage system of claim 1, wherein each of the plurality of helical piles comprises an adjustable pile cap and a helical pile shaft.

4. The energy storage system of claim 3, wherein the adjustable pile cap comprises a plurality of holes configured to connect the energy storage nodes to a helical pile foundation.

5. The energy storage system of claim 1, wherein two adjacent energy storage nodes share a single helical pile, and wherein each of the plurality of helical piles is substantially centered equally in both directions between two of the energy storage nodes.

6. The energy storage system of claim 3, wherein the adjustable pile cap is substantially centered on the helical pile shaft.

7. The energy storage system of claim 3, wherein each of the plurality of helical piles further comprises at least two through bolts or screws attached to the helical pile shaft.

8. The energy storage system of claim 3, wherein the adjustable pile cap is configured to be adjusted in height to level each of the energy storage nodes with respect to the solid substratum.

9. The energy storage system of claim 3, wherein each of the plurality of helical piles comprises an anchor clamp attachment that is through-bolted to the adjustable pile cap through holes drilled into the adjustable pile cap.

10. A method for attaching an energy storage system to a solid substratum, the method comprising:
providing a plurality of energy storage nodes, wherein each of the plurality of energy storage nodes includes a battery storage element; and
coupling each of a plurality of helical piles to a corresponding one of the energy storage nodes,
wherein two adjacent energy storage nodes share a single helical pile or a fixed number of the plurality of helical piles is determined by site soil and seismic conditions.

11. The method of claim 10, wherein each of the plurality of helical piles is configured to be coupled to a corner of the corresponding one of the energy storage nodes.

12. The method of claim 10, wherein two adjacent energy storage nodes share a single helical pile, the method further comprising substantially centering an adjustable pile cap of each helical pile on a helical pile shaft of each helical pile.

13. The method of claim 10, further comprising attaching the adjustable pile cap to each of the plurality of helical piles.

14. The method of claim 13, further comprising adjusting a height of the adjustable pile cap to level each of the plurality of energy storage nodes.

15. The method of claim 14, further comprising drilling holes into the adjustable pile cap of each of the plurality of helical piles for an anchor clamp attachment.

16. The method of claim 15, further comprising through-bolting the anchor clamp attachment to the adjustable pile cap through the holes drilled into the adjustable pile cap.

17. The method of claim 15, wherein the anchor clamp attachment comprises an anchor bolt with two nut mechanical anchors configured to press a grip into an anchor tab of the energy storage nodes and the adjustable pile cap.

18. The method of claim 15, further comprising installing each of the plurality of energy storage nodes to a corresponding one of the plurality of helical piles and tightening the anchor bolts.

19. A system, comprising:
a plurality of helical piles, each of said plurality of helical piles being configured to couple one or more of a plurality energy storage nodes to a solid substratum, wherein each of the plurality of energy storage nodes includes a battery storage element,
wherein a single helical pile is configured to be shared by two adjacent energy storage nodes or a fixed number of the plurality of helical piles is determined by site soil and seismic conditions.
